(19) United States
(12) Patent Application Publication
(10) Pub. No.: US 2006/0102557 A1
(43) Pub. Date: May 18, 2006

(54) Self-remediating filter

(75) Inventor: Peter J. Hurley, West Yorkshire (GB)

Correspondence Address: CHRISTIE, PARKER & HALE, LLP, PO BOX 7068, PASADENA, CA, 91109-7068, US

(73) Assignee: SOLUCORP INDUSTRIES, LTD.

(21) Appl. No.: 11/013,587

(22) Filed: Dec. 16, 2004

Related U.S. Application Data
(60) Provisional application No. 60/530,002, filed on Dec. 16, 2003.

(51) Int. Cl. B01D 39/00

(52) U.S. Cl. 210/502.1

(57) ABSTRACT

Self-remediating filters have a heavy metal remediation agent contained in a water-soluble, polymeric material, adjacent to or disposed in a filter medium. A method of remediating conventional, heavy metal-contaminated filters is also provided, wherein a contaminated filter is allowed to contact an aqueous slurry of a heavy metal remediation agent.

### CROSS-REFERENCE TO RELATED APPLICATION(S)

This application is based on and claims priority of U.S. Provisional Application No. 60/530,002, filed, Dec. 16, 2003, the entire contents of which are incorporated by reference herein.

### BACKGROUND OF THE INVENTION

Heavy metals such as lead, zinc, and chromium are encountered in a number of industrial applications. In the painting industry, such materials are often used as pigments and in the production of anti-corrosion paints used to protect the metal surfaces of structures, airplanes, boats, and other vehicles. Zinc chromate, for example, is widely used in alkyd, epoxy, and polyurethane primers in the aerospace industry, because of its ability to protect aluminum, its thermal stability, and its ability to withstand thermal shock experienced by airplanes. For such uses, it is not easily substituted. Unfortunately, zinc chromate and other heavy metal-containing paints, materials, and their dust are toxic.

When zinc chromate-containing primers and paints are sprayed on surfaces, and when they are removed prior to re-painting, airborne particles are produced. Heavy metal dusts and aerosols are also produced by other industrial processes. Dust and aerosols are controlled within the working environment by constantly filtering the air. Laborers are usually protected from the hazardous dust by protective clothing and face masks with inbuilt filters. Thus, the process of repainting airplanes—as well as a vast number of other industrial applications—gives rise to a waste stream of contaminated clothing, personal air filters, ventilation filters, other environmental filters, and filter residues. The safe treatment and disposal of such waste is regulated in most jurisdictions.

Although filters have been devised that are highly effective at trapping aerosols and particulate matter, including heavy metal dusts and other hazardous wastes, they typically ignore the problem of the spent filter, which becomes impregnated with hazardous substances. Disposing of such a filter in a landfill is environmentally irresponsible, and likely prohibited by various regulations. If exposed to ground water, wind, rain, or other environmental conditions, used filters containing heavy metal particulates pose a substantial environmental hazard, due to their tendency to leach into the surrounding area. There is a substantial need for improved filters capable of remediating lead and other heavy metal that become trapped therein.

### SUMMARY OF THE INVENTION

According to one aspect of the invention, a self-remediating filter is provided and comprises a heavy metal remediation agent contained within a water-soluble, polymeric material, adjacent to or disposed within a filter medium. In one embodiment, the filter comprises at least one water-soluble, polymeric packet containing a heavy metal remediation agent, adjacent to or disposed within at least one filter medium. Together, the packet and remediation agent provide an integrated fixation system (IFS) for heavy metals. Thus, the water-soluble packet functions as a polymeric matrix that separates the remediation agent from the heavy metal(s) to be remediated, in this case, the metal particulates that become trapped in the filter medium. When the used filter is deposited in water, the packet dissolves, releasing the remediation agent, which then “fixes” the heavy metal(s). This effectively renders the metal(s) non-leachable and/or insoluble, enabling the filter to be disposed of in a landfill, at a concomitantly lower cost than would otherwise be the case.

In another embodiment of the invention, a plurality of water-soluble, polymeric “ribbon packets,” each containing a remediation agent, are layered between two or more layers of filter medium, or interspersed within one or more layers of filter medium. The ribbon packets are made using a sleeve sealing machine.

In another embodiment, a water-soluble polymeric packet containing a remediation agent is built into the housing of a filter during manufacture, for example, at the periphery of the filter medium.

The invention improves upon many different types of filters, including air filters used in paint booths, panel filters for buildings, and filter cartridges for personal filtration masks.

In another aspect of the invention, a remediation agent is added to a filter containing heavy metal particles trapped therein, prior to its disposal. The remediation can be applied, for example, as an aqueous slurry.

In still another aspect of the invention, a filter matrix for use in smelting and refining is provided, and comprises a column packed with pellets containing a heavy metal remediation agent encapsulated within a degradable, polymeric matrix.

### BRIEF DESCRIPTION OF THE DRAWINGS

These and other features and embodiments of the invention will become better understood when reference is made to the following detailed description and accompanying drawings, wherein:

FIG. 1 is a schematic illustration of a ribbon of water-soluble packets suitable for holding a heavy metal remediation agent, according to one embodiment of the invention;

FIG. 2 is schematic illustration of a remediating filter according to one embodiment of the invention;

FIG. 3 is a schematic illustration showing an alternate embodiment in which a plurality of remediation packets are adjacent to a filter medium; and

FIG. 4. is a schematic, cross-sectional illustration of a self-remediating filter cartridge according to one embodiment of the invention.

### DETAILED DESCRIPTION OF THE INVENTION

According to a first aspect of the invention, a self-remediating filter is provided and comprises a heavy metal remediation agent contained within a water-soluble, polymeric material; adjacent to or disposed within a filter medium. The filter medium is typically a layer or layers of material capable of filtering particulates, including heavy metal particulates, which may be submicron in size, or larger. Advantageously, after the filter is clogged with particulates or determined to be of no further use, it can be disposed of in an environmentally responsible manner, after immersing it in or spraying it with water.

The water-soluble, polymeric material and the heavy metal remediation agent can be characterized as an “integrated fixation system,” as that term is used in U.S. patent application Ser. No. 09/646,544 (Webster and Hurley), the entire contents of which are incorporated by reference herein. The water-soluble, polymeric material functions as a polymeric matrix that separates the remediation agent from the heavy metals that become trapped within the filter. When the polymeric material is activated (dissolved) by water, the remediation agent is released and “fixes” the heavy metal(s), either by chemical transformation to an insoluble (or at least substantially less soluble) form, or by physical encapsulation of the metal(s), preventing subsequent leaching into the environment.

Nonlimiting examples of remediation agents include calcium sulfide, calcium phosphate, calcium hydroxide, calcium carbonate, calcium oxide, magnesium sulfide, magnesium phosphate, magnesium hydroxide, magnesium carbonate, magnesium oxide, mixed calcium- and magnesium-containing carbonates and phosphates, apatite, di-calcium hydrogen phosphate, calcium di-hydrogen phosphate, triple super phosphate, dolomite, phosphoric acid and its salts, calcium-X-phosphates (where X is a metal ion), alkaline earth silicates, hydrated silica, hydrated alumina, metal sorbing clays, such as Bentonite and Fuller's Earth, and mixtures thereof. “Triple super phosphate” (TSP) is Ca(H₂PO₄)₂.H₂O (CAS No. 65996-95-4). The mineral apatite, Ca₅(PO₄)₃(F,Cl,OH), is functional, but slow. Alkaline earth silicates (e.g., calcium silicate), operate through sorption and as a consequence of their high alkalinity; hence, their effect is likely not permanent. When used by themselves, phosphates are considered suitable for remediation of lead, but they do not remediate other metals. Indeed, application of phosphates to arsenic can actually aggravate leaching.

A preferred remediation agent is MBS™ 2.1, a Molecular Bonding System™-brand remediation agent, from Solucorp Industries (West Nyack, N.Y.). MBS™ 2.1 is a 3:2:1 (wt/wt) mixture of calcium carbonate/calcium sulfide/triple super phosphate. This reagent is capable of rendering insoluble harmful metals trapped in air filters to concentrations below their U.S. Universal Treatments Standard (UTS) limits.

MBS™ 2.1 is not pH-dependent, and can remediate lead under conditions ranging from pH 1 to pH 13. In contrast, phosphates and silicates are pH-dependent, with phosphates functional under broadly neutral conditions (pH 6 to 8), and silicates functional under strongly alkaline conditions (>pH 10). Additionally, the MBS™ remediation agent converts soluble lead salts to lead sulfide, which is non-toxic by oral administration Thus, its use should detoxify filters containing lead particulates.

The amount of remediation agent to be employed depends on a number of factors, including the filter's intended use, the identity of heavy metal(s) likely to be encountered, the choice of remediation agent, the nature of the filter media, and the size and porosity of the filter. For filters enhanced (or treated after use) with an MBS™ remediation agent, and intended for use in paint booths in chromate-based paint de-painting (stripping) operations, wt/wt ratios of remediation agent-to-trapped-paint-residues-in-the-filter of from about 1:4 to about 1:1 are representative, with a ratio of about 1:1 being preferred to achieve reduction in leaching to below UTS limits for hard to treat Cr (VI) wastes. When 100 grams of chromium (VI) paint residues contained within a 10 cm square section of a filter leaching 800 mg/Litre Cr (VI) by TCLP were treated with 50 gram MBS 2.1 in an aqueous slurry, the amount of leaching was reduced only 20 mg/Litre Cr (VI). In contrast, treatment with an amount of MBS remediation agent equal to the amount of paint residues trapped in the filter renders leaching to less than the UTS limit of 0.6 mg/Litre total chromium. Other wastes, for example those based on lead or zinc, require less MBS reagent. The optimum amount of remediation agent for a given filter, heavy metal, and application can be ascertained by a skilled person without undue experimentation.

In one embodiment of the invention, the heavy metal remediation agent is pre-packaged and sealed within a water-soluble, polymeric material comprising a polymeric pouch or packet. Nonlimiting examples of such packets include those made of polyvinyl alcohol (PVA), polyvinyl acetate, and copolymers thereof, and similar materials. Water-soluble packaging is available in a variety of forms and materials, some of which permit dissolution in hot water, and others in cold water. A nonlimiting example is the “Cold Water Soluble PVA Bag” sold by Aquafilm Ltd (A part of MonoSol LLC (Portage, Ind. and Hartlebury, Worcestershire, UK), available in customer-specified dimensions and film thicknesses.

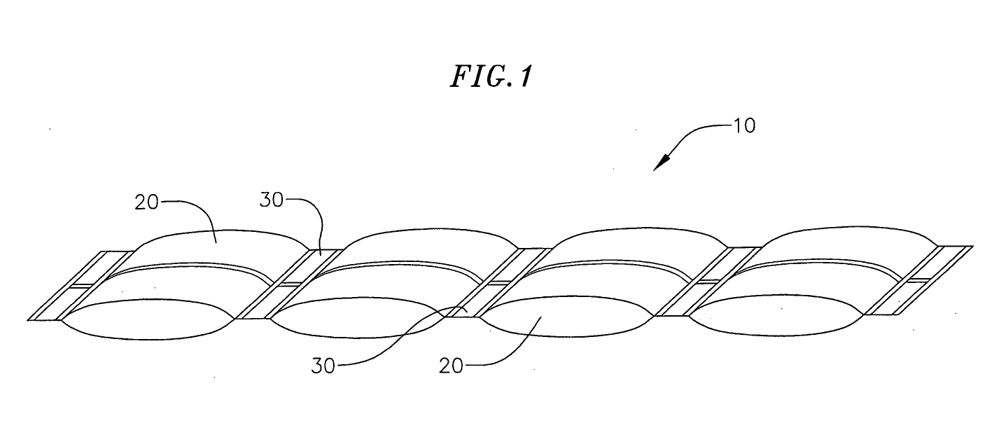

In another embodiment, a ribbon of water-soluble, polymeric packets (shown in detail in FIG. 1) is formed and filled with remediation agent on a vertical form-filling, sleeve-sealing machine The ribbon 10, includes a plurality of spaced apart packets or pouches 20, each of which can be filled with remediation agents. Each packet is separated by a small, sealed region 30. Without being limited to particular dimensions, in one embodiment, a packet ribbon is formed of 50-100 micron thick, cold water soluble PVA film, with each packet approximately 2.5 cm wide and 10 cm long, each holding 50 grams net weight of remediation agent.

In some embodiments of the invention, it is advantageous to include a dispersant or other emulsifier to improve distribution of the remediation agent(s) upon activation of the packet(s) and release into the vicinity of the heavy metal particulates The dispersant can be packaged with, or separately from, the heavy metal remediation agent, in a water-soluble, polymeric material (e.g., a pouch or packet as described above). Nonlimiting examples of dispersants include anionic and non-ionic hyperdispersants, e.g. Sosperse 12000, 22000, 43000, and 44000, from Lubrizol Corp. (Charlotte, N.C.); fatty alcohol alkoxylates, e.g., Brij®, from Uniqema BV (Gouda, The Netherlands); sorbitan esters, e.g., Span® from Uniqema BV; ester alkoxylates, e.g., Tween®, also from Uniqema BV; and conventional cationic detergents. Typical concentrations of dispersant or emulsifier may vary between 100 mg/Litre and 10 g/Litre depending upon the nature of the dispersant or emulsifier. Sufficient quantities should be employed to facilitate the rapid and even dispersion of the remediation agent.

The choice of filter medium depends upon the application(s) for which the filter is designed to be used, and the environment(s) to which it is likely to be exposed. Nonlimiting examples of filter media include glass fibers, paper, cotton, cloth, synthetic, fibers, and mixtures thereof. The filter may have any of a number of configurations, including rolls, pads, cloth bags, jelly roll construction, accordion-pleats, honeycombed, single layer, multilayer, and other forms familiar to persons having skill in the art of filter design and use. Dry filters, which employ the principle of interception, as well as viscosity impingement filters, which employ viscous agents or oils, can be utilized.

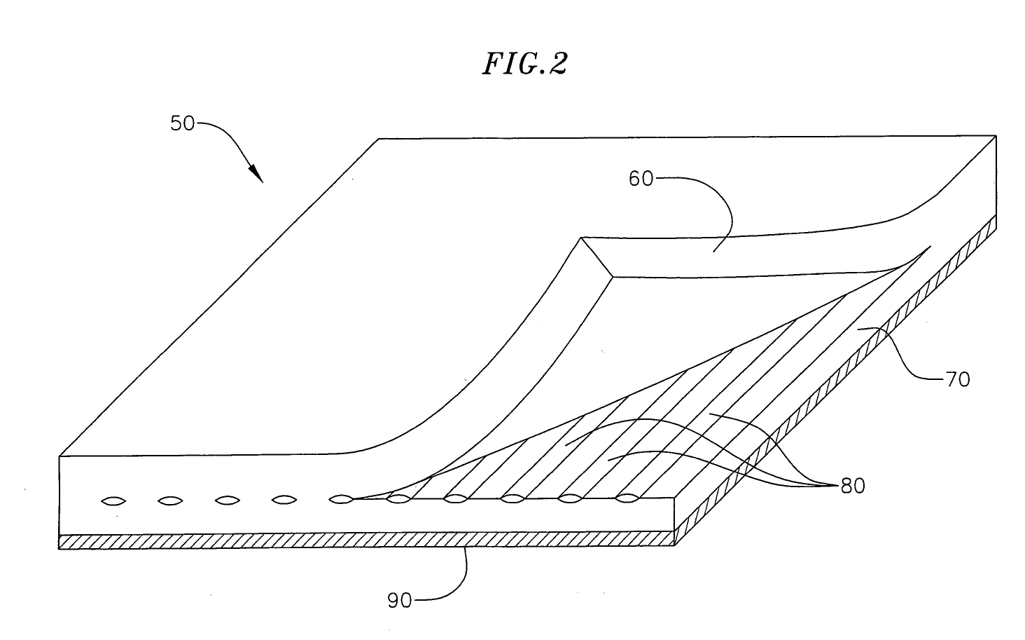

Referring now to FIG. 2, one embodiment of a self-remediating filter is shown. The filter 50 includes a first layer of coarse, non-woven polyester fiber 60, a second layer of coarse, non-woven polyester fiber 70, and a plurality of water-soluble, polymeric packets 80 sandwiched there between. The packets have a ribbon configuration, as described above. Each packet contains a heavy metal remediation agent. The ribbon packets are placed in parallel rows, at intervals of 10 cm, such that there is a 50 gram packet of remediation agent (e.g., MBS™ 2.1) for each 10×10 cm section. An additional filter medium is provided as a thin layer of fine, non-woven polyester fiber 90. The entire assembly is prepared in a convention manner, but with the additional step of placing the packet ribbons between adjoining layers of filter media.

In an alternate embodiment, the packet ribbons are threaded through the center of the coarse section of a filter panel across its width.

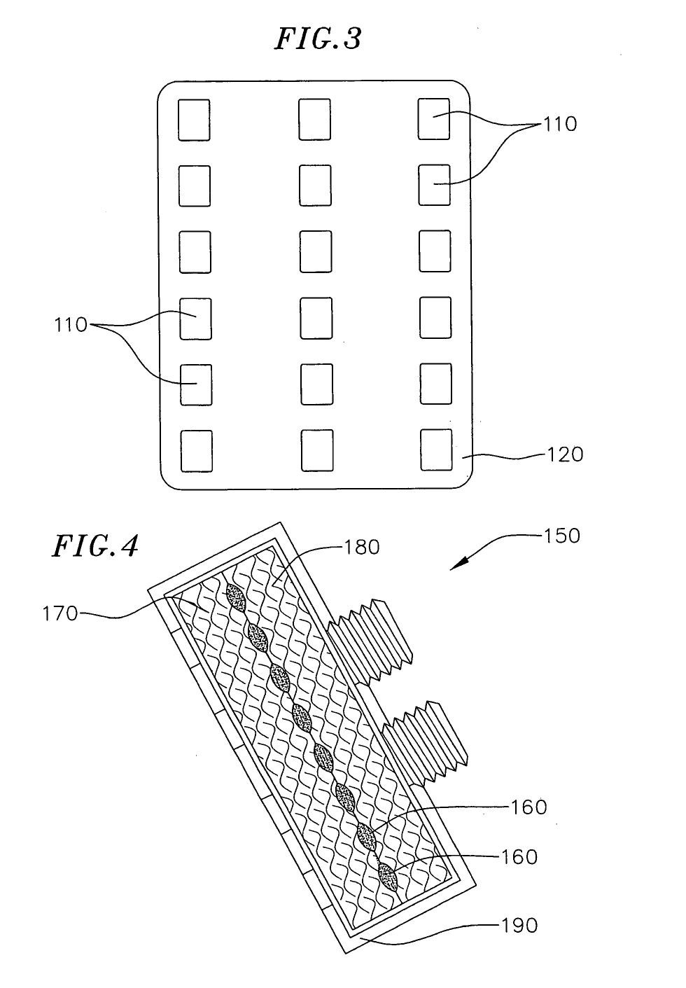

FIG. 3. shows an alternate configuration in which a plurality of discrete packets 110, each containing a heavy metal remediation agent, are placed adjacent to a layer of filter medium 120. Each packet is made of a water-soluble, polymeric material, as described above.

Self-remediating filters according to the present invention can have a plethora of sizes and configurations, and are suitable for use in a wide variety of industrial and other applications. For example, in one embodiment the filter medium is a 1 meter square, 3-10 cm thick, panel of coarse, non-woven polyester fibers. A panel filter for a paint booth (e.g.) includes one or more layers of the filter medium, one or more remediation agent packets, and (optionally) a housing. In another embodiment, shown in FIG. 4, a filter cartridge for a personal air filter is provided. The cartridge 150 includes a plurality of remediation packets 160 interspersed between two layers of filter media 170, 180, held within a cartridge housing 190.

An improved filter according to the invention may be used in a conventional manner. At the end of its useful life, the filter can be immersed in or sprayed with water. Water activates the integrated fixation system in the filter, dispersing the remediation agent internally within and about the filter media, in close proximity to the heavy metal(s) particulates trapped therein. This results in the metal(s) becoming fixed, that is, rendered water-insoluble and/or encapsulated in a non-leachable form. Subject to compliance with government regulations, the filter may then be drained and disposed of as non-hazardous waste. The incorporation of a remediation agent into the filter eliminates the need to rupture the filter prior to treatment. Consequently, the risk to hazardous waste handlers is reduced. Similarly, the cost of handling used filters is lowered.

In another aspect of the invention, rather than including a remediation agent within the filter or filter housing, the agent is added to a conventional filter containing heavy metal particles trapped therein, after use but prior to its disposal. The remediation agent can be applied, for example, as an aqueous slurry. Optionally, a dispersant (as described above) is also included in the slurry. A nonlimiting example of this embodiment is provided below.

### EXAMPLE

Ruptured, used filters containing chromate residues were tested by TCLP and found to leach 598 mg/liter chromium (VI). A 10% w/w aqueous slurry of MBS™2.1 was prepared, and the contaminated filter material was immersed in the slurry, with periodic agitation, for 48 hours. The residues were then removed and drained. Post-treatment analysis by TCLP did not show detectable chromium (VI); the limits of detection was cited as 0.100 mg/liter.

In another aspect of the invention, a filter matrix designed for concentration, recovery, and reuse of heavy metals, as might be required, e.g., in the smelting and refining of valuable and/or volatile heavy metals, is improved by the principles described herein. Water-soluble PVA pellets (approximately 5 mm diameter) are prepared as described in International Application, Publication No. WO 98/39382 (Hamilton and Hurley), and impregnated or mixed with a heavy metal remediation agent. The water-soluble chips plus remediation agent are tumble coated with a water-soluble or biodegradable surface coating layer, for example, a polyethylene glycol wax, to form an integrated fixation system (IFS) akin to that described in U.S. patent application Ser. No. 09/646,544 (Webster and Hurley) The IFS film typically constitutes 0.5 to 20% by weight of the coated pellets, giving the IFS film a relatively high surface area. The IFS pellets are packed into a water jacketed condenser column. Waste gases containing volatile heavy metals, such as arsenic or mercury, are allowed to pass through the chilled column. The volatile metals condense on the surface of the IFS pellets. When the IFS pellets are deemed to be saturated with heavy metals, the column packing is removed and immersed in water. The water-soluble interior of the pellets is dissolved, leaving the heavy metals as insoluble residues concentrated in 0.5 to 20% of the original weight of the column packing. The residue may then be recovered by filtration and disposed of as non-hazardous waste, subject to government regulations, or, alternatively, the potentially valuable metals may be recovered from the residues by electrolytic, smelting, or other recognized metal-winning procedures.

An advantage of this approach is the reduction in volume of remediated sludge that results. The aqueous, metal-free portion can be discarded to the drain. For higher value foundry wastes, or even gold, platinum, and palladium vapors, the sludge is in a concentrated form and can be recycled as a precious metal ore.

The invention has been described with reference to various embodiments and aspects, but is not limited thereto, as other modifications will likely present themselves to the skilled person upon reading this disclosure. Such modifications and equivalents are also considered to lie within the scope of the invention, which is limited only by the following claims.

What is claimed is:

1. A self-remediating filter, comprising:
a heavy metal remediation agent contained within a water-soluble, polymeric material; adjacent to or disposed within a filter medium.

2. A self-remediating filter as recited in claim 1, wherein the heavy metal remediation agent is selected from the group consisting of calcium sulfide, calcium phosphate, calcium hydroxide, calcium carbonate, calcium oxide, magnesium sulfide, magnesium phosphate, magnesium hydroxide, magnesium carbonate, magnesium oxide, mixed calcium- and magnesium-containing carbonates and phosphates, apatite, di-calcium hydrogen phosphate, calcium di-hydrogen phosphate, triple super phosphate, dolomite, phosphoric acid and its salts, calcium-X-phosphates (where X is a metal ion), alkaline earth silicates, hydrated silica, hydrated alumina, metal sorbing clays, and mixtures thereof.

3. A self-remediating filter as recited in claim 1, wherein the heavy metal remediation agent comprises a mixture of calcium carbonate, calcium sulfide, and triple super phosphate.

4. A self-remediating filter as recited in claim 1, wherein the polymeric material comprises a polymeric packet.

5. A self-remediating filter as recited in claim 4, wherein the polymeric packet is made of polyvinyl alcohol, polyvinyl acetate, or a copolymer thereof.

6. A self-remediating filter as recited in claim 1, wherein, wherein the polymeric material comprises a packet ribbon having a plurality of polymeric packets, and wherein the heavy metal remediation agent is contained within the packets.

7. A self-remediating filter as recited in claim 1, further comprising a dispersant.

8. A self-remediating filter as recited in claim 7, wherein the dispersant is contained within the polymeric material.

9. A self-remediating filter as recited in claim 1, wherein the dispersant is selected from the group consisting of anionic hyperdispersants, non-ionic hyperdispersants, fatty alcohol alkoxylates, sorbitan esters, ester alkoxylates, and cationic detergents.

10. A self-remediating filter as recited in claim 1, wherein the filter medium is selected from glass fibers, paper, cotton, cloth, synthetic fibers, and mixtures thereof.

11. A self-remediating filter as recited in claim 1, wherein the filter medium comprises a panel of polyester fibers.

12. A self-remediating filter as recited in claim 1, wherein the water-soluble, polymeric material is sandwiched between two layers of filter media.

13. A self-remediating filter as recited in claim 12, wherein the two layers of filter media are comprised of coarse, polyester fibers.

14. A self-remediating filter as recited in claim 13, further comprising a relatively thin layer of fine, non-woven polyester fibers, adjacent to one layer of filter media.

15. A method of remediating a filter contaminated with a heavy metal, comprising:
contacting the filter with an aqueous slurry containing a heavy metal remediation agent.

16. A method of remediating a filter as recited in claim 15, wherein the heavy metal remediation agent is selected from the group consisting of calcium sulfide, calcium phosphate, calcium hydroxide, calcium carbonate, calcium oxide, magnesium sulfide, magnesium phosphate, magnesium hydroxide, magnesium carbonate, magnesium oxide, mixed calcium- and magnesium-containing carbonates and phosphates, apatite, di-calcium hydrogen phosphate, calcium di-hydrogen phosphate, triple super phosphate, dolomite, phosphoric acid and its salts, calcium-X-phosphates (where X is a metal ion), alkaline earth silicates, hydrated silica, hydrated alumina, metal sorbing clays, and mixtures thereof.

17. A method of remediating a filter as recited in claim 15, wherein the slurry further comprises a dispersant.

18. A method of remediating a filter as recited in claim 17, wherein the dispersant is selected from the group consisting of anionic hyperdispersants, non-ionic hyperdispersants, fatty alcohol alkoxylates, sorbitan esters, ester alkoxylates, and cationic detergents.

19. A self-remediating filter cartridge, comprising:
a housing;
a filter medium within the cartridge; and
a heavy metal remediation agent contained within a water-soluble, polymeric material; adjacent to or disposed within a filter medium.

20. A self-remediating filter cartridge as recited in claim 19, wherein the polymeric material comprises a polymeric packet.
